(19) United States
(12) Patent Application Publication
(10) Pub. No.: US 2008/0185240 A1
(43) Pub. Date: Aug. 7, 2008

(54) Self-Boosting Electromechanical Disk Brake

(76) Inventors: Chi-Thuan Cao, Korntal-Muenchingen (DE); Dietmar Baumann, Hemmingen (DE); Dirk Hofmann, Stuttgart (DE); Herbert Vollert, Vaihingen/Enz (DE); Willi Nagel, Remseck/Hochdorf (DE); Andreas Henke, Diemelstadt (DE); Bertram Foitzik, IIsfeld (DE); Bernd Goetzelmann, Sindelfingen (DE); Hans Frick, Wiggensbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/910,350

(22) PCT Filed: Jul. 12, 2006
(86) PCT No.: PCT/EP2006/064121

§ 371 Date: Oct. 1, 2007

(30) Foreign Application Priority Data
Aug. 5, 2005 (DE) 10 2005 037 009.8

(51) Int. Cl. F16D 65/21; F16D 65/092

(52) U.S. Cl. 188/72.2

(57) ABSTRACT

The invention relates to a self-reinforcing electromechanical disk brake. The invention proposes to produce a lining carrier plate of the disk brake from a fiber composite material. A bending-resistant lining carrier plate can be produced cost-effectively in this way. In addition to fiber-reinforced plastic, steel-reinforced concrete can also be considered as a composite material for the lining carrier plate.

### PRIOR ART

The invention relates to a self-boosting electromechanical disk brake as generically defined by the preamble to claim 1.

Electromechanical disk brakes are known per se. They have an electromechanical actuating device, with which a friction brake lining can be pressed against a brake disk for actuating the disk brake, or in other words for braking. The electromechanical actuating device typically has an electric motor, with which the friction brake lining can be pressed against the brake disk via a rotation-to-translation conversion gear, such as a screw drive. Often, a step-down gear is connected between the electric motor and the rotation-to-translation conversion gear. Still other possibilities for a rotation-to-translation conversion gear exist; for instance, by means of the electric motor, preferably via a step-down gear, a cam may be pivoted that presses the friction brake lining against the brake disk, or a rack-and-pinion gear is used, in which a gear wheel moves a rack that displaces the friction brake lining. The rack need not be straight.

For attaining self-boosting, ramp mechanisms are known, with a ramp or a set of ramps that have an inclination relative to the brake disk; that is, a spacing between the ramp or ramps and the brake disk decreases in a tangential or circumferential direction of the brake disk. The ramps may for instance have a helical course. The inclination of the ramp or ramps may vary over the course of the ramp or ramps, so that the magnitude of self-boosting upon actuation of the disk brake will vary. For instance, at the beginning the ramp or ramps may have a great inclination, so that an air clearance between the friction brake lining and the brake disk at the onset of the actuation of the disk brake can be rapidly overcome, while at their end the ramp or ramps may have a slight inclination, to attain strong self-boosting when the actuation and braking force is strong. If the ramp or ramps have a constant inclination over their length, then the term wedge or wedges and the term wedge mechanism can be used. The ramp or ramps may be disposed on the brake caliper and/or on the friction brake lining, in the latter case preferably on its back side facing away from the brake disk.

The friction brake lining is braced via the ramp or ramps on a brake caliper of the disk brake. For actuation of the disk brake, the friction brake lining is displaced by the electromechanical actuating device along the ramp or ramps until it rests on the brake disk and presses against the brake disk. The rotating brake disk exerts a frictional force on the friction brake lining that urges the friction brake lining in the direction of the ascending ramp or ramps. On the principle of a wedge, the bracing of the friction brake lining on the ramp or ramps exerts a normal force to the ramps on the friction brake lining, which force exerts a normal force component to the brake disk on the friction brake lining and, in addition to a contact pressure exerted by the electromechanical actuating device, presses the friction brake lining against the brake disk. The contact pressure and braking force of the disk brake is boosted as a result. Typically, the friction brake lining is disposed detachably or nondetachably on a front side, toward the brake disk, of a lining carrier plate, on whose back side, facing away from the brake disk, the ramp mechanism or in other words the self-booster device is disposed.

The known disk brakes have a brake caliper, on or in which the electromechanical parts of the disk brake are accommodated; the term “electromechanical parts” should be understood to mean the components of both the electromechanical actuating device and of the self-booster device.

The brake caliper of electromechanical disk brakes is typically, but not necessarily, embodied as a floating caliper; that is, it is displaceable transversely to the brake disk. Upon contact pressure of one friction brake lining against one side of the brake disk, the brake caliper is displaced transversely to the brake disk and presses another friction brake lining against the other side of the brake disk, so that for exerting contact pressure on both friction brake linings, only one electromechanical actuating device and one self-booster device are needed. The electromechanical actuating device and the self-booster device need not be disposed on the same side of the brake disk.

### EXPLANATION AND ADVANTAGES OF THE INVENTION

The lining carrier plate of the self-boosting electromechanical disk brake of the invention, having the characteristics of claim 1, is produced from a composite material. Because of the production from a composite material, the lining carrier plate can be embodied as bending-resistant and torsion-proof. The bending resistance and torsional strength are of greater significance in disk brakes with self-boosting than for instance in conventional hydraulic disk brakes, in which the lining carrier plates are braced over a comparatively large surface area on a brake piston or in the brake caliper. In the case of self-boosting disk brakes, the lining carrier plates are often braced only at some points, for instance with a three-point bracing with three roller bodies that are disposed at the corners of an imaginary triangle on a back side, facing away from the brake disk, of the lining carrier plate. The bending stress and torsional stress on the lining carrier plate is substantially higher than in the case of lining carrier plates, supported in the brake caliper, of disk brakes without self-boosting.

The advantages of the invention are the capability of economical production of the lining carrier plate, its low thermal conductivity, which reduces heat transfer from the friction brake lining to a brake caliper, and good noise damping properties as a function of the composite material.

Further advantages are that composite materials can be processed or in other words produced at low temperatures and are nevertheless heat-resistant and exhibit only slight shrinkage upon production. Close tolerances can be adhered to, so that functional surfaces, such as running surfaces for the roller bodies of the self-booster device, or bearing holes, require no post-machining.

Advantageous features and refinements of the invention defined by claim 1 are the subject of the dependent claims.

As the composite material for the lining carrier plate, a fiber composite material is conceived of in particular, that is, a basic material (matrix) into which threads, fibers, whiskers, mats, woven fabric, or wires of some other or optionally even different materials are incorporated. Plastics, or concrete with a steel reinforcement or some other kind of reinforcement as embedded material, can be given particular consideration as the basic material. It is also possible to consider metals and alloys as the basic material. A different embodiment of the invention provides a laminated composite material for the lining carrier plate. To achieve strong bending strength, layers of materials with high tensile strength can be combined with layers of pressure-resistant materials. For instance, if the back side of the lining carrier plate, facing away from the brake disk, is subjected to tension above all by actuation of the disk brake, and the front side of the lining carrier plate, facing toward the brake disk, is subjected to pressure, then for instance a layer that is resistant to tensile stress is disposed on the back side and a layer that is resistant to pressure is disposed on the front side of the lining carrier plate. Between the two layers, intermediate layers may be provided. The layers may also be provided regionally, in regions that are subjected to tensile and compressive stress.

### DRAWINGS

The invention will be described in further detail below in terms of an exemplary embodiment shown in the drawings. Shown are:

FIG. 1, a self-boosting electromechanical disk brake according to the invention, looking radially from outside toward a brake disk;

FIG. 2, an enlarged view of a detail in the direction of arrow II in FIG. 1;

FIG. 3, a modification of the detail shown in FIG. 2; and

FIG. 4, a cross section through a rack of the disk brake of FIG. 1.

### DESCRIPTION OF THE EXEMPLARY EMBODIMENT

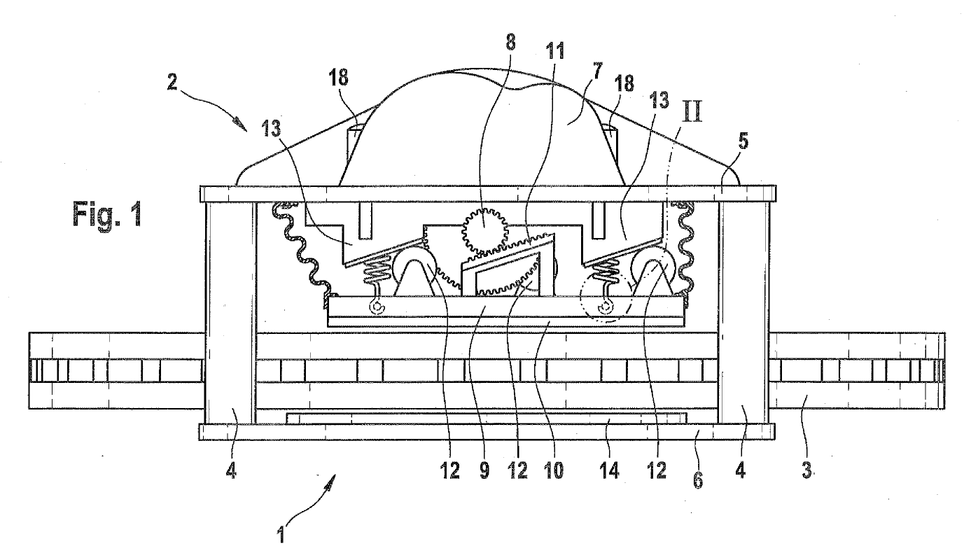

The self-boosting electromechanical disk brake 1 of the invention, shown in FIG. 1, has a brake caliper 2, which is embodied as a floating caliper, or in other words is guided displaceably transversely to a brake disk 3. A sliding guide of the brake caliper 2 is concealed in the drawings by armatures 4 of the brake caliper 2 and cannot be seen. Such sliding guides are known per se and therefore need not be described in detail here.

The brake caliper 2 has two plates 5, 6, spaced apart from and parallel to one another, which are located on both sides of the brake disk 3 and are disposed parallel to the brake disk 3. The two plates 5, 6 are joined together by the armatures 4 on their longitudinal ends. The armatures 4 extend transversely to the brake disk 3 and are disposed outside a circumference of the brake disk 3. The armatures 4 are located approximately in the centers longitudinally of the plates 5, 6, and as a result upon actuation of the disk brake 2, they are essentially subject only to tensile stress and at most only slightly to bending stress, and the plates 5, 6 remain parallel to one another and are not pressed obliquely apart from one another by an actuation or tightening force of the disk brake 1. With the plates 5, 6, which are joined to one another by the armatures 4 and are disposed on both sides of the brake disk 3, the brake caliper 2 forms a so-called frame caliper.

On an inner side of the plate 5, oriented toward the brake disk 3, of the brake caliper 2, there is a lining carrier plate 9 with a fiction brake lining 10, located close to the brake disk 3 and spaced apart from the plate 5. The lining carrier plate 9 with the friction brake lining 10 is movable relative to the plate 5 and to the brake caliper 2. The lining carrier plate 9 has a rack 11, on its back side facing away from the brake disk 3, with which a gear wheel 8 meshes. The rack 11 extends obliquely at an angle to the brake disk 3 and moreover in a circular arc about an axis of rotation of the brake disk 3; that is, the course of the rack 11 is helical.

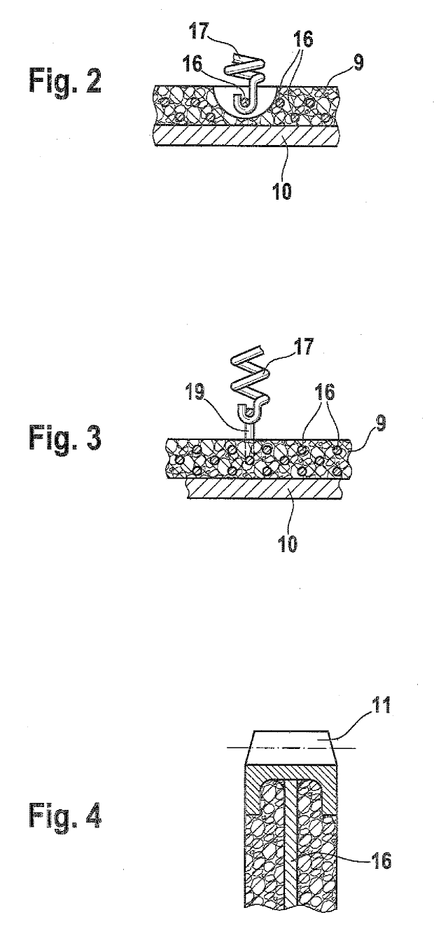

The lining carrier plate 9, via three roller bodies 12 (rollers) that are disposed on its back side and are rotatably supported, is braced on ramps 13, which can also be called wedges, that are disposed on the inside, toward the brake disk 3, of the plate 5 of the brake caliper 2. The ramps 13 extend helically, with the same inclination as the rack 11; that is, they extend at an angle to the brake disk 3 about an axis of rotation of the brake disk 3. The roller bodies 12 are disposed at comers of an imaginary triangle with a long base; two roller bodies 12 and two ramps 13 are located radially farther outward, relative to the brake disk 3, than the third or middle roller body 12 and the associated ramp, which are located in the circumferential direction of the brake disk 3, that is, the longitudinal direction of the plate 5 of the brake caliper 2, between the other two roller bodies 12 and the other two ramps 13. The result is a statically defined three-point bracing of the lining carrier plate 9 in the brake caliper 2. As can be seen in FIG. 2, the ramps 13 have a transverse slope, and the transverse slope of the middle ramp 13, located radially farther inward, extends outward and is thus oriented counter to the transverse slope of the radially outer ramps 13, which slope inward. As a result, longitudinal guidance of the lining carrier plate 9 is achieved. In principle, it is also conversely possible for the middle ramp 13 to be located radially farther outward relative to the brake disk 3 than the other two ramps 13 and/or for the transverse slopes of the ramps 13 to be transposed.

The actuation of the disk brake 2 is effected by means of an electric motor, which via a step-down gear (gear-wheel gear) drives the gear wheel 8 that meshes with the rack 11. The electric motor and the gear are accommodated in a housing 7 in the brake caliper 2 and are therefore not visible in the drawings. The rack 11 and with it the lining carrier plate 9 are moved in the circumferential direction, or more precisely along a helical path, relative to the brake disk 3. In the process, the roller bodies 12 of the lining carrier plate 9 roll on the ramps 13 of the brake caliper 2. The friction brake lining 10 is pressed against the brake disk 3 and displaces the brake caliper 2, embodied as a floating caliper, transversely to the brake disk 3, so that a second friction brake lining 14, disposed fixedly on an inner side, toward the brake disk 3, of the other plate 6 of the brake caliper 2, is also pressed against the other side of the brake disk 3. The brake disk 3 is braked. The electric motor, the step-down gear, and the rack 11 form an electromechanical actuating device of the disk brake 2.

The rotating brake disk 3 exerts a frictional force in the circumferential direction on the friction brake linings 10, 14 pressed against it, which force urges the lining carrier plate 9 in its displacement direction. The bracing of the lining carrier plate 9 on the ramps 13 of the brake caliper 2 by the roller bodies 12, because of the oblique course of the ramps 13 relative to the brake disk 3, exerts a normal force to the ramps 13 on the so-called wedge principle, which force acts on the roller bodies 12. This normal force to the ramps 13 has a component that is transverse to the brake disk 3 and that in addition to the contact pressure generated by the electric motor presses the lining carrier plate 9 with the friction brake lining 10 against the brake disk 3. This increases the braking force. The roller bodies 12 and the ramps 13 form a self-booster device of the disk brake 2.

The lining carrier plate 9 is a component comprising a composite material, specifically, in the exemplary embodiment shown and described, a fiber composite material. This may for instance be a fiber-reinforced plastic, in which the fibers may also be embedded (not shown) in the form of mats or woven fabrics in a plastic as the basic material (matrix). In the exemplary embodiment of the invention shown and described, the composite material comprising the lining carrier plate 9 is concrete, as the basic material, with a steel reinforcement 16. The steel reinforcement 16 may be thought of as fibers, while the concrete with the steel reinforcement 16 can to this extent be considered to be a fiber composite material. The illustration is the same except for the shading.

In the lining carrier plate 9 shown in FIG. 2, a recess which exposes a steel reinforcement 16 is provided in the lining carrier plate 9. A restoring spring 17 is suspended in this steel reinforcement. The restoring spring 17 pulls the lining carrier plate 9 in the direction of the brake caliper 2 and, when the disk brake 1 is not actuated, lifts the friction brake lining 10 from the brake disk 3. In FIG. 3, a steel reinforcement 16 is bent to form an eyelet 19, in which the restoring spring 17 is fastened. The exposed steel reinforcement 16 and the eyelet 19 form fastening elements for suspending the restoring spring 17. Instead of being integral with the steel reinforcement 16, the eyelet 19 or other fastening element can engage the reinforcement, or in the case of a fiber-reinforced plastic it can engage the fiber reinforcement, from behind in order to anchor it well in the basic material, or in other words in the lining carrier plate 9.

As can be seen in FIG. 4, the rack 11 is joined to the steel reinforcement 16 of the lining carrier plate 9 by welding. For producing the lining carrier plate 9, it is possible to shape the steel reinforcement 16 into a three-dimensional structure and to weld the rack 11 onto it. The steel reinforcement 16 is then placed in a mold and encased in concrete.

1-5. (canceled)

6. A self-boosting electromechanical disk brake, comprising:
an electromechanical actuating device;
a friction brake lining disposed on a lining carrier plate;
a brake disk which is pressed against by the friction brake lining upon actuation of the electromechanical actuating device; and
a self-booster device interposed between the electromechanical actuating device and the friction brake lining, the self-booster device converting a frictional force, exerted by rotation of the brake disk against the friction brake lining pressed against the brake disk, into a contact pressure of the self-booster device, which presses the friction brake lining against the brake disk in addition to a contact pressure exerted by the electromechanical actuating device, wherein the lining carrier plate comprises a composite material.

7. The self-boosting electromechanical disk brake as defined by claim 6, wherein the lining carrier plate comprises a laminated composite material or a fiber composite material.

8. The self-boosting electromechanical disk brake as defined by claim 6, wherein the lining carrier plate has a rack disposed thereon which is driven by the electromechanical actuating device, and wherein the rack comprises a wear-resistant material.

9. The self-boosting electromechanical disk brake as defined by claim 8, wherein the rack is joined to a reinforcement of the composite material.

10. The self-boosting electromechanical disk brake as defined by claim 6, wherein the lining carrier plate has a fastening element, which is joined to a reinforcement of the composite material.
